(19) United States
(12) Patent Application Publication
(10) Pub. No.: US 2008/0027673 A1
(43) Pub. Date: Jan. 31, 2008

(54) Method for tracking and rewarding a child's exercise activity by use of a pedometer and computer interface

(76) Inventor: Ryan M. Trumm, Santa Cruz, CA (US)

Correspondence Address: Ryan M. Trumm, 116 Scenic St., Santa Cruz, CA, 95060, US

(21) Appl. No.: 11/492,661

(22) Filed: Jul. 26, 2006

(51) Int. Cl. G01C 22/00

(52) U.S. Cl. 702/160

(57) ABSTRACT

A method for tracking and rewarding a child's exercise activity by use of a pedometer and computer interface with the steps of providing a pedometer having a pet shape connecting with a computer and associated web site. The user connects the pedometer to the computer to download the site information to the pedometer and upload the pedometer information to the site. The uploaded data shows the amount of activity the user has achieved. The personal web site prompts the user to exercise for an appropriate period of time to keep the virtual pet happy. The user periodically uploads pedometer data to the web page and views amount of points gained. The points relate to the health of the virtual pet. Points can be used in games or traded for prizes.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of activity tracking methods and more specifically to a method for tracking and rewarding a child's exercise activity by use of a pedometer and computer interface.

It is well known that children must participate in a certain level of physical activity to remain healthy. In years past, it was common for children to spend hours of play time running, jumping walking and otherwise involved in physical activity so that their bodies remained in good physical shape and condition. More recently, children have been lured to activities that do not require great amounts of physical activity such as watching TV or playing video games. One activity that children seem to love is that of taking care of a pet, even if that pet is in the form of a doll such as a stuffed animal or in the form of a virtual pet such as the Tamagotchi toys that were popular in the 1990's. More recently a very popular web site called NeoPets.com allows children to take care of a virtual pet by logging onto a web site. It would seem therefore, that by linking a child's physical activity level with the care of a virtual pet, that the child would be motivated to exercise more with the object of keeping his or her virtual pet happy.

One way to track physical activity in a child is to attach a standard pedometer to the child's clothing and measure the amount of walking or running the child does.

Takahiro Harada et al in their U.S. Pat. No. 6,302,789 show a pedometer with a game mode that shows a character in a display which changes based on the physical activity of a child. William Bliss, in his U.S. Pat. No. 3,834,702 shows a jogging game where the user jogs in place to move game pieces.

Although the Harada et al patent discloses a pedometer with a game mode were a virtual character is affected by the amount of the child's activity, it does not allow a child to track his or her physical activity progress through connection to the Internet and does not allow the child to accrue points based on activity level that can be traded in for prizes. The Bliss patent, now in the public domain, establishes the concept of using a physical activity to cause a result in a game but does not extend the idea to a complete method of tracking physical activity and using the Internet to interact with a person to reward him or her for the amount of their activity.

### BRIEF SUMMARY OF THE INVENTION

The primary object of the invention is to provide a method for tracking a child's exercise activity through the use of a pedometer and a computer interface.

Another object of the invention is to provide a method of storing and displaying exercise records on a personal web site.

Another object of the invention is to provide a pedometer that has a pet shape or pet graphic so that the user relates to the pedometer as a virtual pet.

A further object of the invention is to provide a pet shaped pedometer that provides visual and or audible pet related cues to tell the user whether or not they have gotten enough exercise.

Yet another object of the invention is to provide a point scoring and tracking system that allows the user to collect a reward for amount of exercise performed.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a method for tracking and rewarding a child's exercise activity by use of a pedometer and computer interface comprising the steps of: providing a pedometer having a pet shape or a pet type graphic panel with the capability of connecting with a computer, said computer capable of connecting with a dedicated web site, a user capable of registering his or her pedometer on said web site as a virtual pet, giving it a pet name and creating a password so that said user has exclusive access to his or her virtual pet, said user to have a custom home page on said web site, said home page including pet name, and personal data such as age, weight, name, likes and dislikes, said user connects said pedometer to said computer via a USB port or other standard connection means such as Bluetooth or Firewire, and presses sync button on said web page to download said site information to said pedometer and upload said pedometer information to said site, said uploaded data showing the amount of activity the user has achieved as measured by said pedometer and said activity capable of being viewed in the form of charts and graphs, history to date, average health to date and reward points, said personal web site page capable of prompting said user to exercise for an appropriate period of time to keep said virtual pet happy, said personal web site page also capable of allowing the user to play exercise related games, explore health related topics and have access to sponsor links. Said user makes use of the pedometer by turning it on by means of an on/off button at which point said virtual pet's eyes light up indicating that said pedometer is in the on mode, said user placing said pedometer on his or her clothing by means of a belt clip or clothing grip, said user's walking or running activity being recorded on said pedometer thereby accumulating points, said pedometer making audible sounds and vibrating periodically to communicate said user's level of physical activity and virtual pet happiness, said pedometer making positive sounds or comments if activity is at proper health level and said pedometer making negative sounds or comments if activity is at less than proper health level, Optionally, said pedometer can operate in a silent mode where said activity level can be communicated via an LCD display or other visual means, said user periodically uploading said pedometer data to said personal web page and viewing amount of points gained within a given time period, said points relating the the health of said virtual pet, adequate points resulting in a healthy pet, very low points resulting in the possible death of the pet, and said points capable of being used in games or traded for prizes.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a block diagram showing the steps involved in the method of the present invention.

FIG. 2 is a front plan view of the pedometer of the present invention.

FIG. 3 is a side view (of head end of pedometer, oriented horizontally) of the present invention.

FIG. 4 is a rear plan view of the pedometer of the present invention.

FIG. 5 is a plan view of the pedometer of the present invention with the cover in the open position.

FIG. 6 is a perspective view of the pedometer of the present invention.

FIG. 7 is a side view (of foot end of pedometer, oriented horizontally) of the present invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

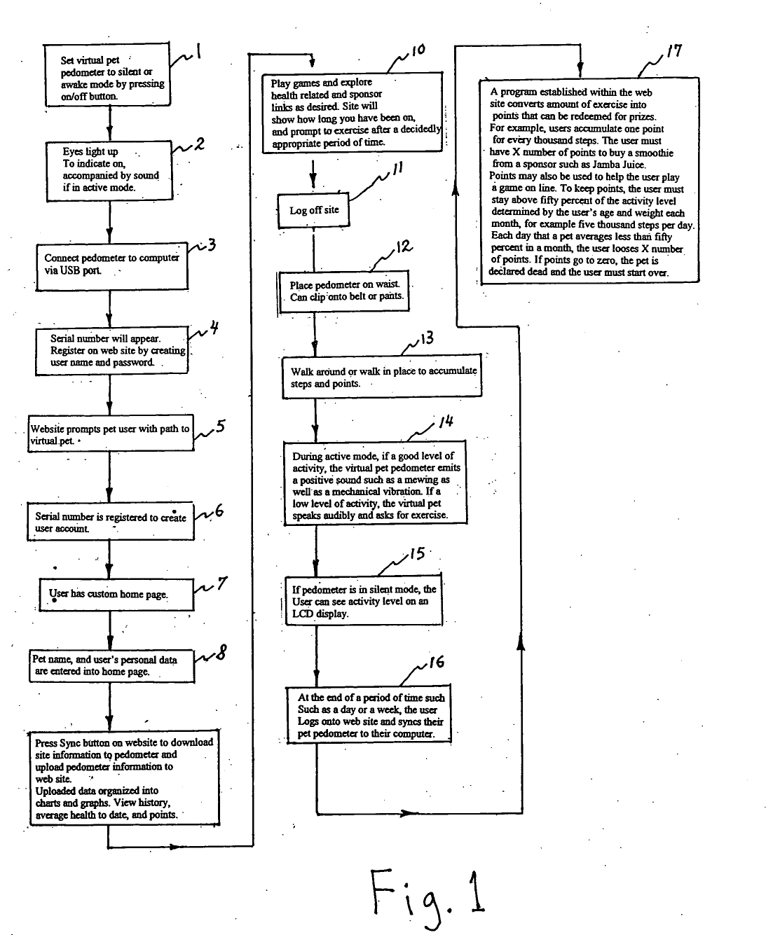

Referring now to FIG. 1 we see a flow chart that explains the method of tracking and rewarding a child's activity by use of a pedometer and computer interface.

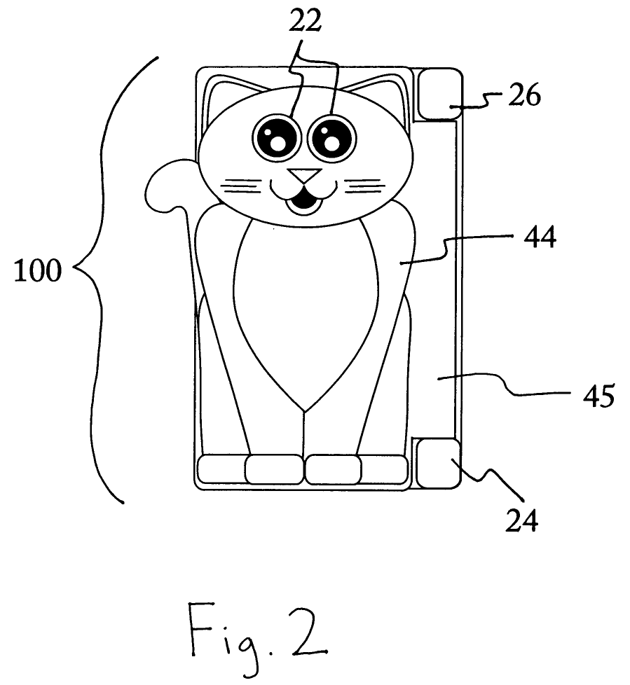

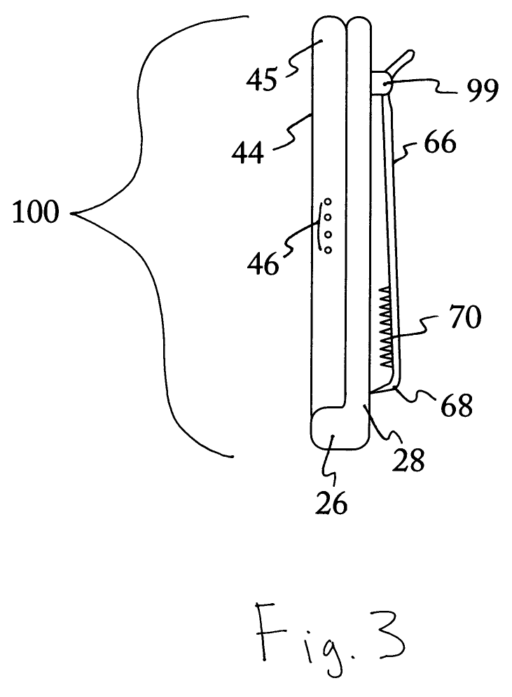

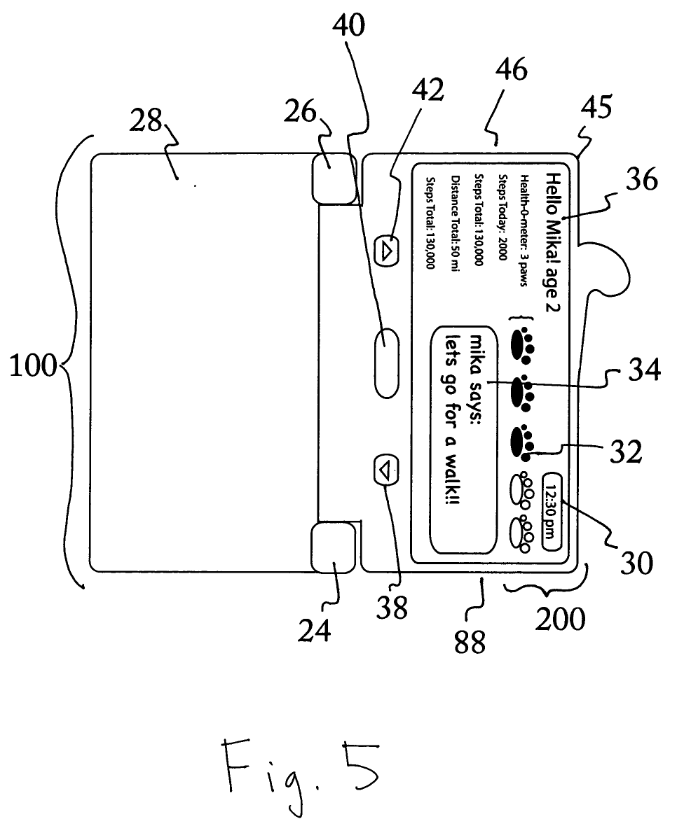

I will describe this chart fully below, but first will describe the novel pedometer device 100 that is used to record a child's walking and running activity. Pedometer 100 is standard in that it contains a power source and the standard electro-mechanical elements to count and record the user's steps. However other novel features will be presented below. FIG. 2 shows a front view of the pedometer 100 of the present invention. The pedometer has a cat shape 44 located on the front of housing 45 that includes a graphic representation of a cat. The cat can be considered a virtual pet. Obviously, the pet of choice can be changed to any other animal such as a dog, monkey or hamster or other fictional or nonfiction character. Prior success with products such as “Tamagochi” show that children are motivated to keep a virtual pet happy. The present invention uses this motivating factor to have the child's physical activity be the criteria for the health of the virtual pet. The more the activity of the child, as recorded by the pedometer 100, the greater the health of the virtual pet. The cat 44 has a pair of LED's 22 in located in the eye portion. These LED's blink when the pedometer is working, showing visually that the unit 100 is in the on mode. Hinges 24, 26 allow a back panel 28, shown in FIGS. 5, 3, and 7, to open revealing a keypad consisting of forward and backward command buttons 38, 42 and an on/off button 40. Also appearing is an LCD screen 200 that displays information such as time and day 30, the health of the virtual pet as indicated by number of paw prints or other suitable icon shown 32 as well as written words 34 that the virtual pet is saying to the owner. Additional information 36 can include the owner's name, the pet's name, a count of number of steps walked today and total steps walked in a given period of time such as a week and a conversion to distance in feet or miles. Speaker holes 46 allow verbal comments and animal sounds such as “mew” to be emitted from the device 100. Additionally, a standard vibrator, not shown, located within the housing 45, can be activated and act as a “purring” response to the fact that the virtual pet is getting enough exercise and is healthy.

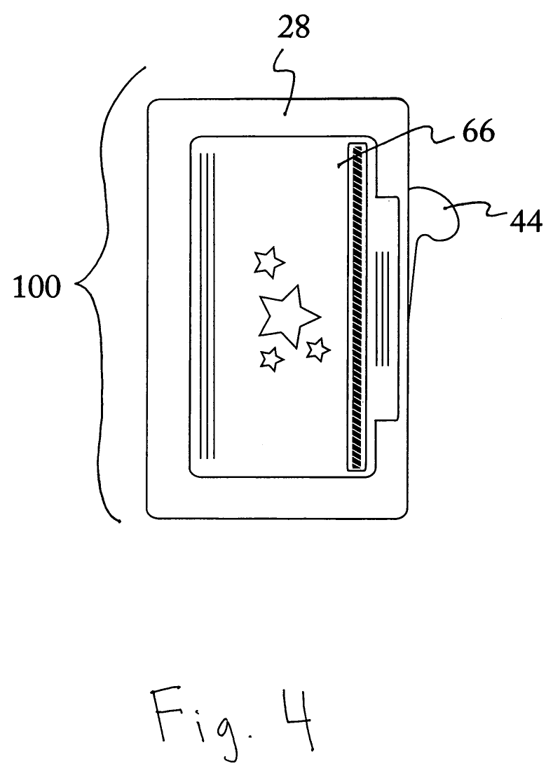

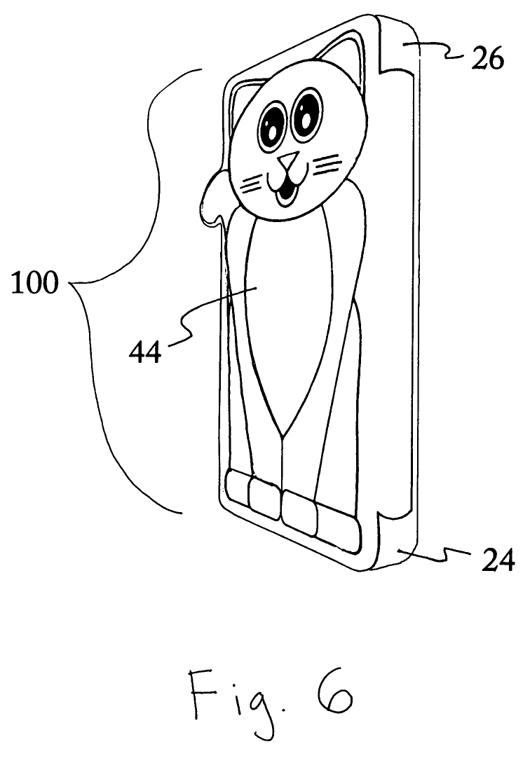

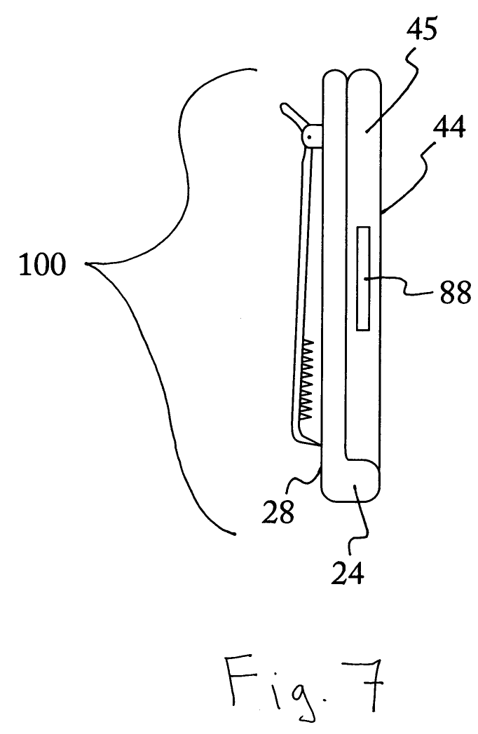

FIG. 3 shows a (head) side view of the invention100, oriented horizontally. In this view a standard retaining clip 66 can be clearly seen. The standard clip is spring biased 99 and includes an L shaped member 68 to hold the clip 66 onto a standard belt, and also includes a plurality of ridges 70 to hold the clip onto an article of clothing such as a pants waist. Hinge 26, and speaker holes 46 can also be clearly seen. The pedometer 100 works in the standard way to measure and record the number of steps that the user takes while wearing the unit 100. FIG. 4 is a rear view of the invention 100. FIG. 6 is a perspective view of the invention. FIG. 7 is a (foot) side view of the invention, oriented horizontally. This view shows a USB port 88 that is used to connect the pedometer 100 with a standard computer so that the pedometer 100 can sync up with a web site as will be explained below.

Referring back to FIG. 1, we see a flow chart diagram of the method of use of the pedometer 100 and a dedicated web site that the user interacts with. The user first turns the unit on causing LED's in the pets eyes to flash 2. The user sets the pedometer 100 to the awake or silent mode 1. The awake mode causes the pedometer 100 emit audible sounds such as words of encouragement from the pet, as well as vibration cues that show that the pet is happy. The user then connects the pedometer 100 to a standard computer 3 by attaching a cable to the USB port 88 located on the side of the pedometer 100 and plugging the other end of the cable into a port on the computer. A serial number 4 will appear on the computer's screen and the user will register his information to create a personal account thereby receiving a password and a user name. The web site prompts the user with a path to his or her virtual pet 5. The serial number is used to create a user account 6. The user can then create a custom home page 7 that includes the pet name, and user's personal data 8. The user then presses the “sync” button on the web site page to upload site information to the pedometer 100 and to download pedometer information to the web site 9. Downloaded data is organized into charts and graphs. The user can also view a history of exercise performance and average health to date. The user can also view points collected as a result of physical activity as measured by pedometer 100. The user can also play games and explore health related information. Links to sponsor's sites can be seen 10. The site will show how long the user has been on and prompt the user to exercise for an appropriate period of time to insure that the virtual pet remains happy and healthy. The user can then log off the site 11.

The user then places the pedometer 100 on his or her waist 12 via retaining clip 66. The user can walk, run, or jump in place to accumulate steps and points 13. During active mode, if a good level of activity is achieved, the virtual pet pedometer emits a positive sound such as a mewing as well as a purr which is felt as a mechanical vibration. If a low level of activity is achieved, the virtual pet pedometer 100 speaks audibly and asks for exercise 14. If the pedometer 100 is in silent mode 15, the user can see activity level on an LCD display 200. At the end of a period of time such as a day or week, the user logs onto the web site and syncs their pet pedometer 100 to their computer 16. A program established within the web site converts amount of exercise into points that can be redeemed for prizes 17. For example, a user accumulates one point for every thousand steps. The user must have X number of points to receive a smoothly drink from a sponsor such as Jamba Juice. Points may also be used to help the user play a game on line. To keep points, the user must stay above fifty percent of the activity level determined by the user's age and weight each month, for example, five thousand steps per day. Each day that a pet averages less than fifty percent in a month, the user looses X number of points. If the number of points reaches zero, the pet is declared dead and the user must start over.

In the above described and illustrated way, a child can participate in an exercise program with the motivation of keeping a virtual pet alive and happy. Because of the interaction between the pedometer and a dedicated web site, a wide variety of incentives can be added to keep the user actively engaged in healthful physical activity which is much needed in our sedentary society today. Obviously, the present invention may be used by people of any age, however, for the sake of the preferred embodiment, the word “child” has been used in the above description.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A Method for tracking and rewarding a child's exercise activity by use of a pedometer and computer interface comprising the steps of:
providing a pedometer having a pet shape or a pet type graphic panel with the capability of connecting with a computer;
said computer capable of connecting with a dedicated web site;
a user capable of registering his or her pedometer on said web site as a virtual pet, giving it a pet name and creating a password so that said user has exclusive access to his or her virtual pet;
said user to have a custom home page on said web site;
said home page including pet name, and personal data such as age, weight, name, likes and dislikes;
said user connects said pedometer to said computer via a USB port or other standard connection means and presses sync button on said web page to download said site information to said pedometer and upload said pedometer information to said site;
said uploaded data showing the amount of activity the user has achieved as measured by said pedometer and said activity capable of being viewed in the form of charts and graphs, history to date, average health to date and reward points;
said personal web site page capable of prompting said user to exercise for an appropriate period of time to keep said virtual pet happy;
said personal web site page also capable of allowing said user to play exercise related games, explore health related topics and have access to sponsor links;
said user turning on said pedometer by means of an on/off button at which point said virtual pet's eyes light up indicating that said pedometer is in the on mode;
said user placing said pedometer on his or her clothing by means of a belt clip or clothing grip;
said user's walking or running activity being recorded on said pedometer thereby accumulating points;
said pedometer making audible sounds and vibrating periodically to communicate said user's level of physical activity;
said pedometer making positive sounds or comments if activity is at proper health level and said pedometer making negative sounds or comments if activity is at less than proper health level;
said pedometer optionally can operate in a silent mode where said activity level can be communicated via an LCD display or other visual means;
said user periodically uploading said pedometer data to said personal web page and viewing amount of points gained within a given time period;
said points relating to the health of said virtual pet, adequate points resulting in a healthy pet, very low points resulting in the possible death of the pet;
and said points capable of being used in games or traded for prizes.

2. Method for tracking and rewarding a child's exercise activity by use of a pedometer and computer interface as claimed in claim 1 wherein said pedometer includes;
a belt clip;
a clothing gripping means;
an LCD screen;
a power source such as a battery;
an on/off button;
a keypad;
a microprocessor capable of managing, recording and transmitting exercise related information;
a pair of LED's located in the eye area of said pet shape or graphic;
an audible and vibratory means for periodically communicating to the user the amount of walking or running type exercise has been done within a fixed period of time; and
a USB port or other standard computer connection means to allow said activity related information to be uploaded to said computer or downloaded from said computer.
